(19) United States
(12) Patent Application Publication
(10) Pub. No.: US 2026/0326906 A1
(43) Pub. Date: Oct. 22, 2026

(54) AIRCRAFT PROPULSION SYSTEM AND AN AIRCRAFT

(71) Applicant: Airbus Operations SAS, TOULOUSE (FR)

(72) Inventors: Pierre-Antoine COMBES, TOULOUSE (FR); Nicolas JOLIVET, TOULOUSE (FR); Marc DE NICOLA, TOULOUSE (FR); Olivier PAUTIS, TOULOUSE (FR)

(21) Appl. No.: 19/649,618

(22) Filed: Apr. 16, 2026

Related U.S. Application Data
(60) Provisional application No. 63/790,505, filed on Apr. 17, 2025.

(51) Int. Cl. B64D 27/40

(52) U.S. Cl. CPC B64D 27/404; B64D 27/406

(57) ABSTRACT

A mounting assembly for securing an aircraft engine to a wing via a pylon. The mounting assembly including a front engine mount with two rods extending between front engine lugs and a pylon yoke and two shackles extending between pylon lugs and engine lugs. A fail safe lug is provided between the engine and the pylon to take up loads upon the failure of another component.

### CROSS-REFERENCE TO RELATED APPLICATIONS

This application which claims the benefit of U.S. Pat. Application Ser. No. 63/790,505, filed on Apr. 17, 2025, the entire disclosures of which are incorporated herein by way of reference.

### FIELD OF THE INVENTION

The present invention relates to an aircraft propulsion system and an aircraft with a propulsion system, and in particular wherein the propulsion system includes a turbojet engine and attachment means for securing the turbojet engine to the aircraft.

### BACKGROUND OF THE INVENTION

An aircraft conventionally has a plurality of propulsion systems. Each propulsion system is generally secured underneath a wing of the aircraft and includes a powerplant, for example, a turbojet engine, secured under the wing and attachment means for securing the turbojet engine under the wing.

Although current propulsion systems are satisfactory and meet the necessary requirements, the assembly and disassembly of the attachment means or mounting assemblies which connect a pylon and an engine are generally lengthy and complex. There is an ongoing need and desire to provide to mounting assemblies that reduces installation time and complexity while meeting the necessary requirements.

### SUMMARY OF THE INVENTION

New engine mounting assemblies have been invented. The new engine mounting assemblies do not generate major aero hard-points for external aerodynamic lines. Additionally, in the new engine mounting assemblies, failsafe scenarios are fully considered. Further, the engine mounting assemblies architecture is defined so that the loads at each interface are reasonable and well distributed between each interface. In addition to meeting the foregoing requirements, in the new engine mounting assemblies, the engine to pylon interfaces provide an easy/simple accessibility for engine installation/removability.

According to one or more aspects, the present invention may be characterized as providing a mounting assembly for securing an aircraft engine to an aircraft pylon, the mounting assembly comprising: a front engine mount configured to attach the aircraft engine to the pylon, the front engine mount including: two front rods each extending between a front engine lug of the engine and a yoke of the pylon; two shackles each extending between a pylon lug and an engine lug positioned aft of the front engine lug; and a waiting fail-safe lug extending between the aircraft engine and the pylon; wherein the front engine mount is configured to take up loads in six degrees of freedom between the aircraft engine and the pylon in intact operating conditions; and wherein the waiting fail-safe lug is configured to remain substantially unloaded during intact operating conditions and to transfer loads between the engine and the pylon upon failure of at least one of the two front rods or the two shackles.

The two front rods may be configured to transmit loads along longitudinal, transverse, and vertical axes of the aircraft engine.

The shackles may be oriented within a vertical-longitudinal plane of the engine. The shackles may be configured to transmit engine torque loads to the pylon.

The waiting fail-safe lug may be positioned at a forward end of the pylon.

The waiting fail-safe may include a predefined gap such that the waiting fail-safe lug is not load-bearing during intact operating conditions. The predefined gap may be configured to close upon failure of one of the two front rods, a rear rod, or one of the two shackles.

The waiting fail-safe lug may be configured to transfer vertical loads following engagement.

The front engine mount may be statically determinate during intact operating conditions. The engagement of the waiting fail-safe lug following a component failure may maintain constraint of all six degrees of freedom between the engine and the pylon.

The front engine mount may provide a dual load path for at least one of translational or rotational loads.

The mounting assembly may include rear rods extending between the aircraft engine and the pylon. The rear rods may not be doubled. The rear rods may be doubled to distribute loads following failure of another component.

The shackles may not be doubled.

According to one or more aspects, the present invention may also be characterized as providing an aircraft comprising: a fuselage; a wing extending from the fuselage; a pylon secured to the wing; an aircraft engine; and a mounting assembly as described herein securing the engine to the pylon.

These and other aspects and embodiments of the present invention, any of which may be combined in any manner with any other aspect, embodiment or configuration, will be appreciated by those of ordinary skill in the art based upon the following description of the drawings and detailed description.

### BRIEF DESCRIPTION OF THE DRAWINGS

The characteristics of the invention will emerge more clearly from a reading of the following description of at least one example of embodiment, said description being produced with reference to the accompanying drawings, among which:

FIG. 1 is a side view of an aircraft comprising an assembly according to the invention;

FIG. 2 is a side view of an assembly according to the invention;

FIG. 3A is a schematic representation of conventional structure with single load paths;

FIG. 3B is a schematic representation of structure with dual load paths;

FIG. 4 is a side view of an assembly according to the invention showing loads taken up by the components of the assembly;

FIG. 5 is a close-up view of the front engine mount of an assembly according to the invention;

FIG. 6 is another side view of an assembly according to the invention;

FIG. 7 is a further side view of an assembly according to the invention;

FIG. 8 is a front and side view of the assembly according to the invention showing loads taken up by the components of the assembly;

FIG. 9 is a front and side view of the assembly according to the invention showing loads taken up by the components of the assembly in case of a failure of a front rod;

FIG. 10 is a front and side view of the assembly according to the invention showing loads taken up by the components of the assembly in case of a failure of a shackle; and,

FIG. 11 is a front and side view of the assembly according to the invention showing loads taken up by the components of the assembly in case of a failure of a rear rod.

In general, the same reference numbers will be used throughout the drawing(s) and accompanying written description to refer to the same or like parts.

### DETAILED DESCRIPTION

As mentioned above, new engine mounting assemblies have been invented.

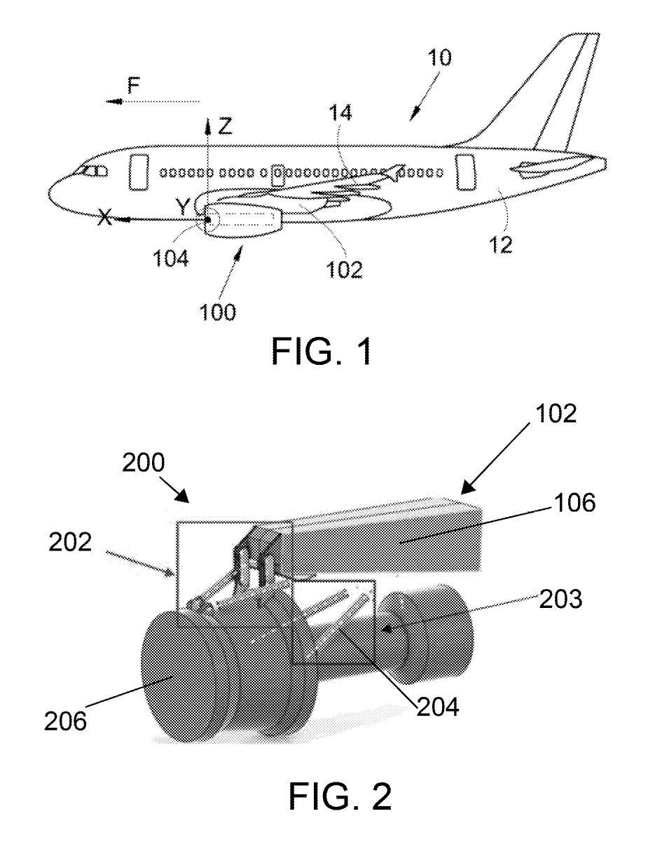

FIG. 1 shows an aircraft 10 which has a propulsion system 100. The aircraft 10 has, on both sides of a fuselage 12, a wing 14 to which an engine pylon 102 is fixed. The propulsion system 100 generally includes the engine pylon 102 and an engine 104.

In the following description, and by convention, X is called the longitudinal axis of the engine oriented positively in the direction of advance of the aircraft 10, it is called Y, the transverse axis of the engine which is horizontal when the aircraft is on the ground, and Z, the vertical axis or vertical height when the aircraft is on the ground, these three axes X, Y and Z being mutually orthogonal. The fore and aft positions are taken in relation to the forward and aft of the aircraft 10. The direction of advancement of aircraft 10 is given by the arrow F which shows the direction in which aircraft 10 advances when engines 104 are running. The engine 104 has a vertical median plane P (XZ).

In the frame of the aircraft engine 104 with high loads to be transferred from the engine 104 to the wing 14, there are specific requirements for engine mounts systems between the pylon 102 and the engine 104.

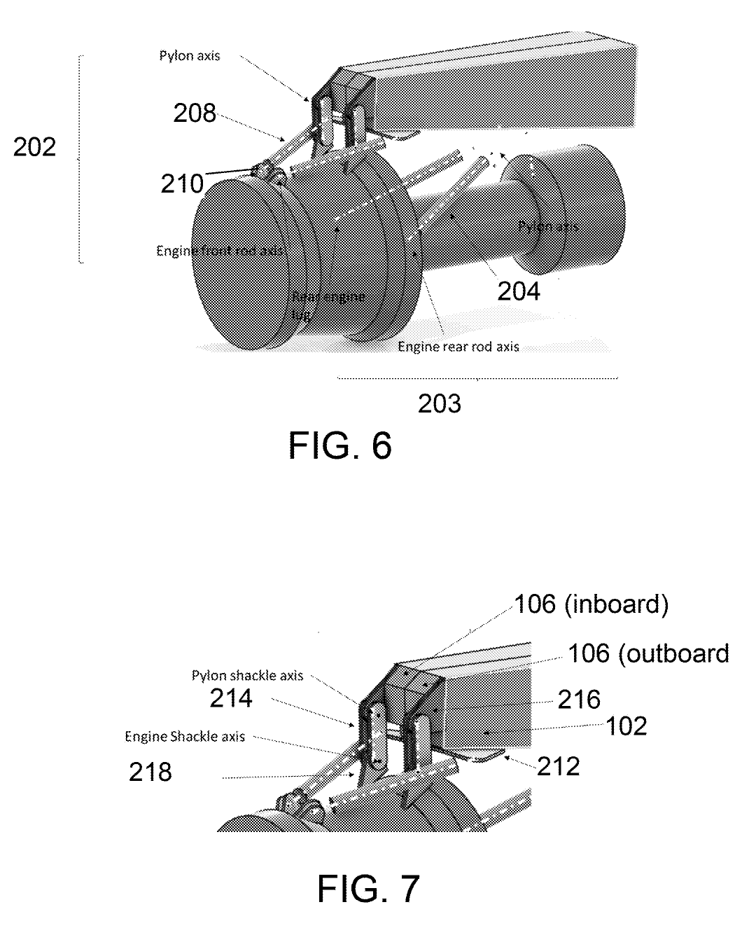

The new engine mounting assemblies 200 are shown FIGS. 2 and 4-11 with front engine mounts 202. The new engine mounting assemblies 200 also include rear engine mounts 203 with rear rods 204 connecting the core of the engine 104 to the pylon 102.

The front engine mounts 202 are disposed above the fan casing 206 of the engine 104, and utilize using various mechanical attachment structures (rods, mechanical parts, etc.). In general, the arrangement of mechanical parts between the pylon 102 and engine 104 can be: in a deterministic manner (6 Degrees of Freedom); in a deterministic manner (6 Degrees of Freedom) with a waiting failsafe interface; or in a statically undetermined manner (more than 6 Degrees of Freedom) (hyperstatism). In the presently depicted embodiment, the embodiment is a dual load path without waiting failsafe.

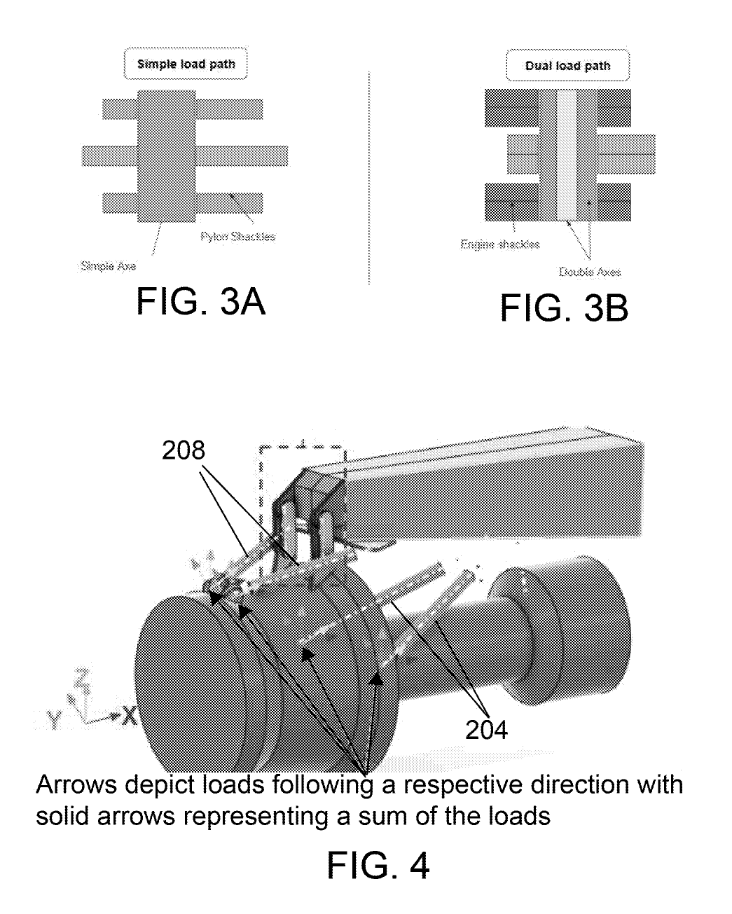

As may be used herein, a “dual load path” refers to a structure that is fail safe when it is damage tolerant: in case of failure or rupture (total or partial) of one of its components, it can continue to ensure its functions, at least up to the next inspection control. To continue performing these functions, the constituent elements are doubled. The two-part main support allows the transmission of loads along the X, Y and Z axes via two different paths. This design does not introduce any moment into the front support or into the forward mount. A conventional structure is shown in FIG. 3A and an example dual load path structure is depicted in FIG. 3B.

As can be seen in FIG. 4, the present embodiment of the invention includes two sets of rods 204, 208 to ensure a widespread attachment to the engine 104, thus making the best of the available wheelbases between engine strong frames. Working in a pair, these rods 204, 208 with a XYZ-projection help transferring all loads (TX, TY and TZ) and balancing moments (especially MY and MZ). As shown in FIG. 4, the color of the arrows reflects the direction in which the loads are flowing in the depicted embodiment.

As can be seen in FIG. 4, the present embodiment of the invention includes two sets of rods 204, 208 to ensure a widespread attachment to the engine 104, thus making the best of the available wheelbases between engine strong frames. Working in a pair, these rods 204, 208 with a XYZ-projection help transferring all loads (TX, TY and TZ) and balancing moments (especially MY and MZ). As shown in FIG. 4, the color of the arrows reflects the direction in which the loads are flowing in the depicted embodiment.

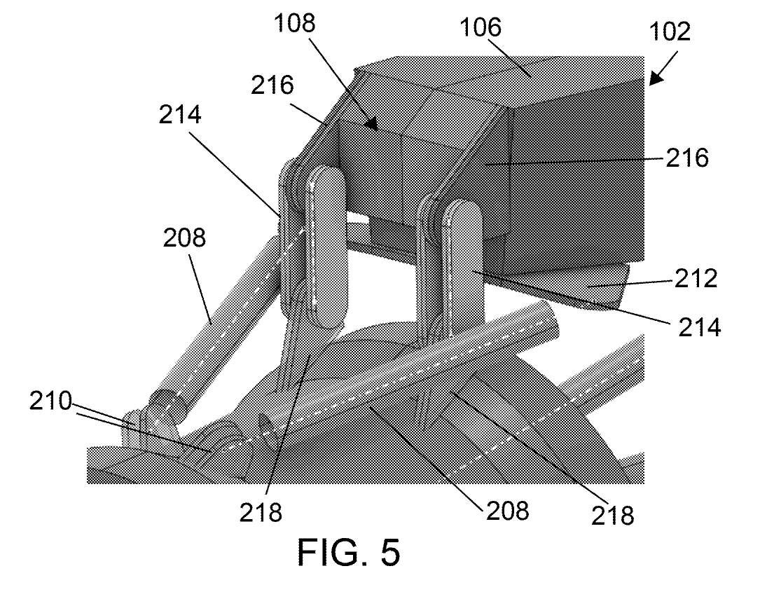

Turning to FIGS. 5-7, the front rods 208 extend between front engine lugs 210 and a yoke 212 on the pylon 102. Ball bearings (not shown) may be present at each end of the rods 204, 208.

The front engine mounts 202 also includes front shackles 214 with interfaces distributed within the volume of the front rib 106 (called N1) of the pylon box 108. The front shackles 214 extend between pylon lugs 216 and mid engine lugs 218. The compact design optimizes the aerodynamic integration of the area, which is very sensitive because it is blown by the fan jet and close to the propeller of the engine 104.

The load inputs are aligned with the main webs of the structural partitions constituting the pylon box 108: the vertical shackles 214 borne by the lateral panels of the front rib 106 are contained in a XZ-plane. Their projection is in a pure Z-direction (vertical) so that they ensure the balancing of the MX (Engine Torque).

The axis of the shackles 214 goes through the lateral panels and the strong rib 106, thus loading both parts in shear and preventing the introduction of additional moments in the pylon box 108.

The system 200 depicted in the present embodiment is statically determinate, which means that all interfaces are required to maintain the 6 DoFs. The failure of one of the interfaces would not guarantee the connection of the engine 104 to the pylon 102. It is therefore mandatory to render all interfaces fail safe.

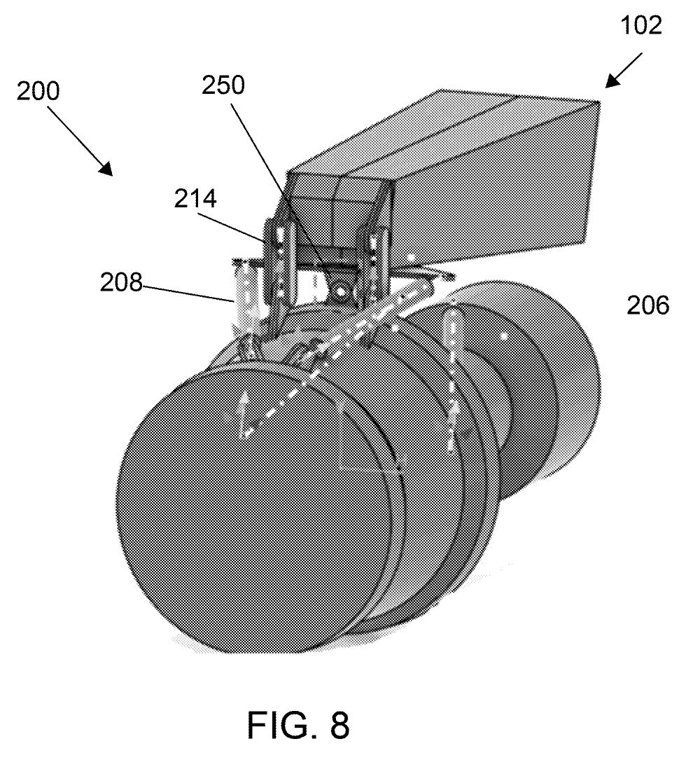

As shown in FIGS. 8-11, in the present assembly, a waiting fail safe (WFS) lug 250 is provided. As the present embodiment remains statically determinate, none of the interfaces can be lost without being compensated elsewhere (to keep 6DoFs blocked). The WFS lug 250 reduces the need to double other components located at the forward end of the pylon 102. This WFS lug 250 accommodates any component failure of the mounts: front rods 208, rear rods 204, or shackles 214. However, it is possible to double some components (for example, the rear rods 204) to better distribute the loads to preserve acceptable loads level. For simplicity reason, on the below drawings, the shackles 214 are shown as being doubled but it is not necessary because of the WFS lug 250.

The WFS lug 250, in normal conditions, is not transferring any loads. When one of the components is defective, this WFS lug 250 will be then activated and fulfill the load transfer function. The WFS points added at YO is a lug installed with a gap so that it is not engaged itself in intact (normal) conditions. In case of a failed rod 204, 208 or shackle 214, the gap would close which would engage that lug 250 for transferring vertical loads.

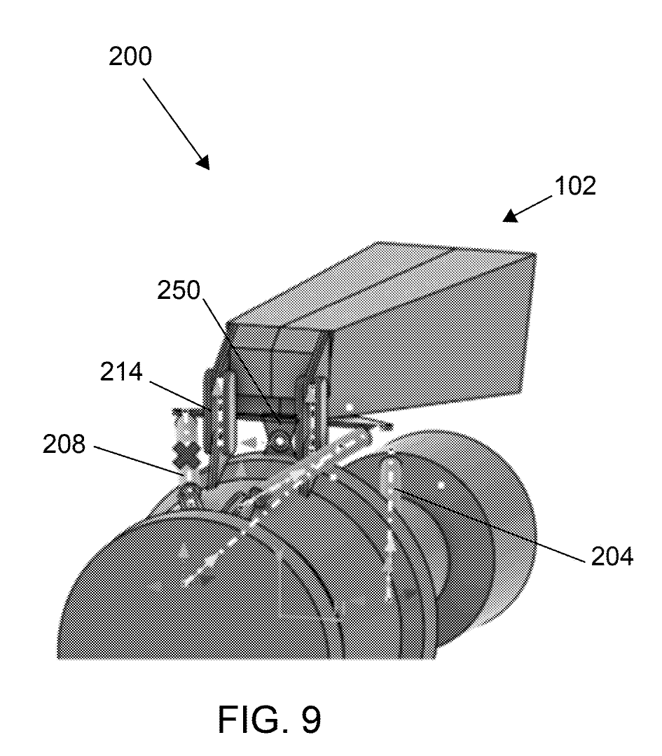

FIGS. 9-11 depict different scenarios of a failed position with a red cross illustrating the location of the failure. The arrows in FIGS. 9-11 indicate which loads are going through which the components.

In FIG. 9, a front rod 208 is indicated as failed. The WFS lug 250 takes up the necessary loads.

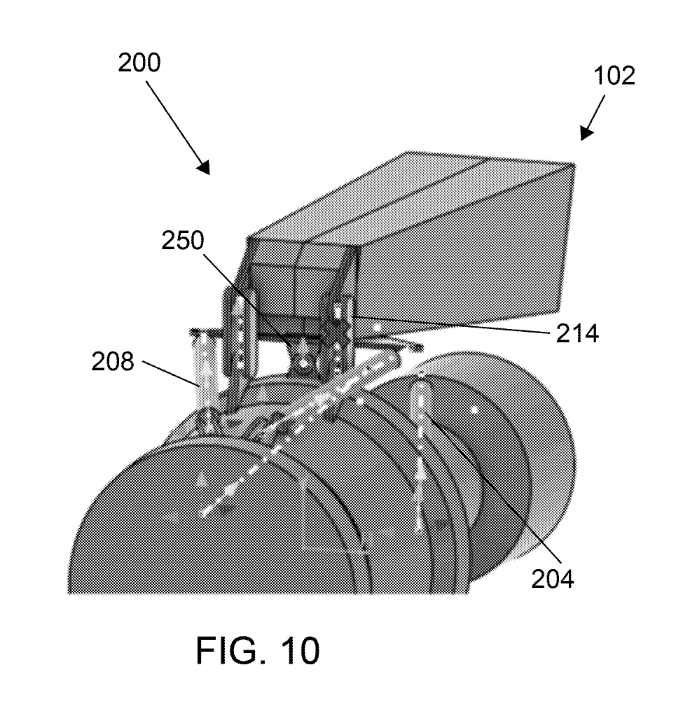

In FIG. 10, a shackle 214 is indicated as failed. The WFS lug 250 takes up the necessary loads.

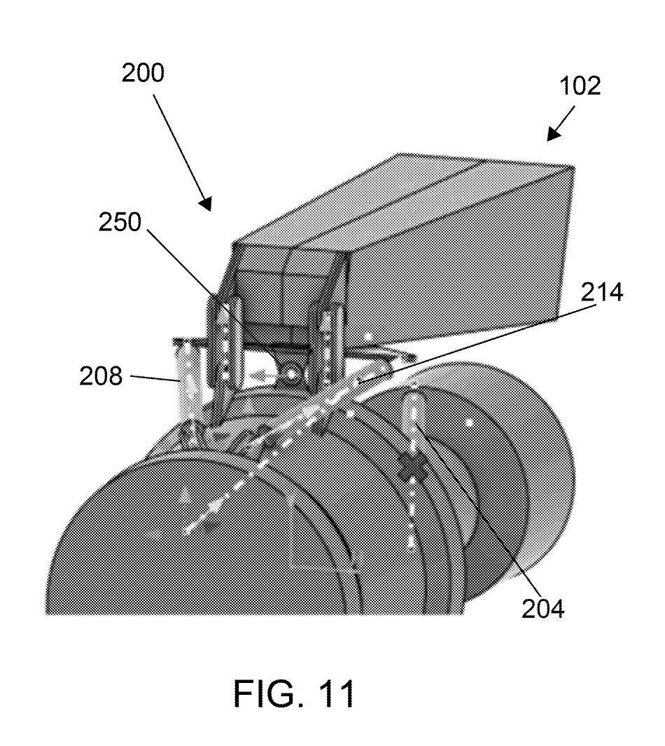

In FIG. 11, a rear rod 204 is indicated as failed. The WFS lug 250 takes up the necessary loads.

According to the present invention, the following components form the fail-safe system: front rods 208 (not doubled); rear rods 204 (could be but are not required to be doubled) including the following doubled elements: rear engine lug, engine rear rod axis, rear rod, pylon axis; and, shackles 214: not doubled.

The present configuration ensures that 6 DoFs are maintained in failed conditions. Loads are still transferred from the engine 104 to the pylon 102 and moments are balanced correctly. Slight additional moments might be induced by the asymmetry introduced to the mounting system by the WFS lug 250. Fortunately, the failed conditions need to demonstrate a feasibility under limit loads only and for a specific inspection interval.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms

“comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A mounting assembly for securing an aircraft engine to an aircraft pylon, the mounting assembly comprising:
a front engine mount configured to attach the aircraft engine to the pylon, the front engine mount including:
two front rods each extending between a front engine lug of the engine and a yoke of the pylon;
two shackles each extending between a pylon lug and an engine lug positioned aft of the front engine lug; and
a waiting fail-safe lug extending between the aircraft engine and the pylon;
wherein the front engine mount is configured to take up loads in six degrees of freedom between the aircraft engine and the pylon in intact operating conditions; and
wherein the waiting fail-safe lug is configured to remain substantially unloaded during intact operating conditions and to transfer loads between the engine and the pylon upon failure of at least one of the two front rods or the two shackles.

2. The mounting assembly of claim 1, wherein the two front rods are configured to transmit loads along longitudinal, transverse, and vertical axes of the aircraft engine.

3. The mounting assembly of claim 1, wherein the shackles are oriented within a vertical-longitudinal plane of the engine.

4. The mounting assembly of claim 3, wherein the shackles are configured to transmit engine torque loads to the pylon.

5. The mounting assembly of claim 1, wherein the waiting fail-safe lug is positioned at a forward end of the pylon.

6. The mounting assembly of claim 1, wherein the waiting fail-safe lug includes a predefined gap such that the waiting fail-safe lug is not load-bearing during intact operating conditions.

7. The mounting assembly of claim 6, wherein the predefined gap is configured to close upon failure of one of the two front rods, a rear rod, or one of the two shackles.

8. The mounting assembly of claim 1, wherein the waiting fail-safe lug is configured to transfer vertical loads following engagement.

9. The mounting assembly of claim 1, wherein the front engine mount is statically determinate during intact operating conditions.

10. The mounting assembly of claim 9, wherein engagement of the waiting fail-safe lug following a component failure maintains constraint of all six degrees of freedom between the engine and the pylon.

11. The mounting assembly of claim 1, wherein the front engine mount provides a dual load path for at least one of translational or rotational loads.

12. The mounting assembly of claim 1, further comprising:
rear rods extending between the aircraft engine and the pylon.

13. The mounting assembly of claim 12, wherein the rear rods are not doubled.

14. The mounting assembly of claim 12, wherein the rear rods are doubled to distribute loads following failure of another component.

15. The mounting assembly of claim 1, wherein the shackles are not doubled.

16. An aircraft comprising:
a fuselage;
a wing extending from the fuselage;
a pylon secured to the wing;
an aircraft engine; and
the mounting assembly of claim 1 securing the engine to the pylon.
